(19) United States
(12) Patent Application Publication
(10) Pub. No.: US 2002/0131643 A1
(43) Pub. Date: Sep. 19, 2002

(54) Local positioning system

(76) Inventors: Sol Sidney Fels, Vancouver (CA); Eduardo Fernando Casas, Vancouver (CA); Jack Hon Wai Ng, Markham (CA); Yin Fung Tang, Ottawa (CA)

Correspondence Address: DOWELL & DOWELL PC, SUITE 309, 1215 JEFFERSON DAVIS HIGHWAY, ARLINGTON, VA, 22202

(21) Appl. No.: 09/803,992

(22) Filed: Mar. 13, 2001

(51) Int. Cl. G06K 9/62

(52) U.S. Cl. 382/224

(57) ABSTRACT

A method and apparatus for finding the position of an object in a space involves identifying the positions of pixels in an image of the space, which satisfy a condition relating to a pixel property associated with the object, classifying the positions into a group according to classification criteria, and producing a group position representation for the group, from positions classified in the group, the group position representation representing the position of the object in the space.

### BACKGROUND OF THE INVENTION

1. Field of Invention

This invention relates to apparatus and methods for finding the position of an object in a space, and more particularly, for finding the position of an object in a space from an image of the space.

2. Description of Related Art

Global positioning systems (GPS) use orbiting satellites to determine the position of a target which is, in general, located in an outdoor environment. Because GPS satellites are not designed to penetrate through construction materials, using GPS to track the movement of objects inside a building is not a practical solution. Moreover, the maximum resolution achieved by GPS is usually too coarse for applications in relatively small spaces.

Locating systems are used inside buildings to enable an operator to determine whether a person or an object is in a particular zone in a plurality of zones of an area. However, locator systems do not have the ability to determine the position of a person or an object within a zone. For example, locator systems do not have the ability to determine which paintings from a closely spaced group of paintings a visitor looks at for an extended period of time in a museum and further would not have the ability to determine areas of highly concentrated traffic flow in a particular zone of a building.

Another problem associated with locator systems is that the locating algorithm is usually executed in software on a host computer which analyzes complete frames of a video image frame by frame to determine whether a person or an object is in a particular part of a space in a representation of the image. This requires processing entire frames at once which usually involves processing a large amount of data for each frame received. The time associated with analyzing the data becomes a bottleneck to quick real time location of a person or an object in a zone. Since cameras have a variable capture rate of typically 30 video frames per second, this sampling frequency imposes a constraint on the processing time of the system in order for it to function properly in real time. If this constraint is not met, information in multiple video frames becomes corrupted and consequently it becomes difficult to detect the person or object in a zone.

What would be useful therefore is a reliable, cost effective system that accurately locates the positions of objects in real time in an indoor environment.

### SUMMARY OF THE INVENTION

The present invention addresses the above needs by providing a method and apparatus for finding the position of an object in a space.

In accordance with one aspect of the invention, there is provided a method of finding the position of an object in a space involving identifying the positions of pixels in an image of the space, which satisfy a condition relating to a pixel property associated with the object, classifying the positions into a group according to classification criteria, and producing a group position representation for the group, from positions classified in the group, the group position representation representing the position of the object in the space.

The method may include producing the image, dividing the image into zones, such as adjacent zones, and identifying the positions of pixels in a zone of the image, which satisfy the condition. Pixel positions satisfying the condition and in a zone may be associated with the same group as pixel positions satisfying the condition in an adjacent zone and within a threshold distance of each other.

The method may also include identifying the position of an up-edge or down-edge pixel having a difference in intensity relative to an intensity of a nearby pixel, where the difference in intensity is greater or less than a threshold value, and identifying the positions of pixels between the up-edge and the down-edge pixels. Alternatively, the positions of pixels having an intensity greater than a threshold value may be identified.

The method may also include associating the pixel positions satisfying the condition and within a threshold distance of each other with the same group, and classifying the positions into a plurality of groups and combining group position representations of the plurality of groups into a single group position representation. Classifying may also involve associating the pixel positions in the same zone satisfying the condition and within a threshold distance of each other with the same group, associating the pixel positions in adjacent zones satisfying the condition and within a threshold distance of each other with the same group and/or associating the pixel positions satisfying the condition and within a threshold distance of each other with the same group.

In this way, a large amount of extraneous information in the image can be eliminated and a much smaller set of data representing the position of the object can be processed quickly to enable detection and tracking of targets in real time.

Successive group position representations representing positions within a distance of each other may be correlated, and the method may include determining whether the successive group position representations are within a target area. The target area may be redefined to compensate for movement of the object in the space.

The method may further include identifying a pattern in the group position representation, such as a spatial pattern in a set of group position representations or a time pattern in the group position representation, and associating the group position representation with an object when the pattern matches a pattern associated with the object. The target area may be deleted when the pattern does not match a pattern associated with the object.

The method may further include transforming the group position representation into a space position representation, wherein the space position representation represents position coordinates of the object in the space.

The method may also include executing the method steps described above for each of at least one different image of the space to produce group position representations for each group in each image, and transforming the group position representations into a space position representation, wherein the space position representation represents position coordinates of the object in the space.

In accordance with another aspect of the invention, there is provided an apparatus for finding the position of an object in a space including provisions for identifying the positions of pixels in an image of the space, which satisfy a condition relating to a pixel property associated with the object, provisions for classifying the positions into a group according to classification criteria, and provisions for producing a group position representation for the group, from positions classified in the group, the group position representation representing the position of the object in the space.

In accordance with another aspect of the invention, there is provided a computer readable medium for providing instructions for directing a processor circuit to identify the positions of pixels in an image of the space, which satisfy a condition relating to a pixel property associated with the object, classify the positions into a group according to classification criteria, and produce a group position representation for the group, from positions classified in the group, the group position representation representing the position of the object in the space.

In accordance with another aspect of the invention, there is provided an apparatus for finding the position of an object in a space. The apparatus includes a circuit operable to identify the positions of pixels in an image of the space, which satisfy a condition relating to a pixel property associated with the object, a circuit operable to classify the positions into a group according to classification criteria, and a circuit operable to produce a group position representation for the group, from positions classified in the group, the group position representation representing the position of the object in the space.

The apparatus may include an image-producing apparatus operable to produce the image, which may include a charge-coupled device or a complementary metal-oxide semiconductor device having an analog-to-digital converter, and/or a plurality of image-producing apparati. The image-producing apparatus may include a filter.

The circuit operable to identify and the circuit operable to classify may further include an application specific integrated circuit or a field programmable gate array in communication with the image-producing apparatus, and may also include a digital signal processor. The digital signal processor may include an interface port operable to be in communication with a field programmable gate array and a processor circuit. The interface port may include an internal direct memory access interface port.

The field programmable gate array, the image producing apparatus and the digital signal processor may be connected serially to form a pipeline that allows parallel processing. This parallelism provides for an efficient processing of the information obtained from the image producing apparatus.

The circuit operable to identify may be operable to identify positions of pixels in a zone of the image, which satisfy the condition, and may be operable to associate the pixel positions with the same group as pixel positions satisfying the condition and in an adjacent zone and within a threshold distance of each other.

The circuit operable to identify may be operable to identify the position of an up-edge and a down-edge pixel having a difference in intensity relative to an intensity of a nearby pixel, where the difference in intensity is greater or less than a threshold value, and may be operable to identify the positions of pixels between the up-edge and the down-edge pixels. Alternatively or in addition, the circuit may be operable to identify the positions of pixels having an intensity greater than a threshold value.

The circuit operable to identify may also be operable to associate the pixel positions satisfying the condition and within a threshold distance of each other with the same group, and to classify the positions into a plurality of groups and to combine group position representations of the plurality of groups into a single group position representation. The circuit may also be operable to associate the pixel positions in the same zone or adjacent zones satisfying the condition and within a threshold distance of each other with the same group.

The circuit operable to produce may also be operable to correlate successive group position representations representing positions within a distance of each other, and determine whether the successive group position representations are within a target area. The circuit may also be operable to redefine the target area to compensate for movement of the object in the space.

The circuit operable to produce may also be operable to identify a pattern in the group position representation, such as a spatial pattern in a set of group position representations or a time pattern in the group position representation, and may be operable to associate the group position representation with an object when the pattern matches a pattern associated with the object. The circuit may be operable to delete the target area when the pattern does not match a pattern associated with the object.

The circuit operable to produce may further be operable to transform the group position representation into a space position representation, wherein the space position representation represents position coordinates of the object in the space, and may also be operable to execute the method steps described above for each of at least one different image of the space to produce group position representations for each group in each image, and to transform the group position representations into a space position representation, wherein the space position representation represents position coordinates of the object in the space.

In accordance with another aspect of the invention, there is provided an apparatus including a housing securable to a movable object movable within a space, an energy radiator on the housing operable to continuously radiate energy, and a circuit operable to direct the energy radiator to continuously radiate energy in a radiation pattern matching an encoded radiation pattern at a receiver operable to receive the energy to produce an image of the radiation pattern to be used to detect the radiation pattern, and operable to transform pixel positions in the image into a position representation representing the location of the movable object in the space.

The energy radiator may be operable to continuously radiate energy as a modulated signal. The energy radiator may be a near-infrared emitting diode operable to emit radiation in the range of 850 to 1100 nanometers. The modulated signal may comprise 10 bits of data which may further comprise error-correcting bits. The apparatus may also include a power supply operable to supply power to the energy radiator and the circuit. The circuit may include a micro-controller operable to direct the energy radiator to radiate a modulated signal comprising bit error correcting bits.

In accordance with another aspect of the invention, there is provided a system for finding the positions of an object in a space. The system includes an image producing apparatus operable to produce an image of the object in the space, an energy radiating apparatus operable to continuously radiate energy to be received by the image producing apparatus, and a position producing apparatus. The position producing apparatus includes a circuit operable to identify the positions of pixels in the image of the space, which satisfy a condition associated with the object, a circuit operable to classify the positions into a group according to classification criteria, and a circuit operable to produce a position representation for the group, for positions classified in the group.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is an isometric view of a system for finding the position of an object in a space, according to a first embodiment of the invention;

FIG. 2 is a schematic representation of an image of the space produced by the camera shown in FIG. 1;

FIG. 3 is a block diagram of major components of the system shown in FIG. 1;

FIG. 4 is a block diagram of a field programmable gate array (FPGA) shown in FIG. 3;

FIGS. 5a and 5b are a flowchart of a zone pixel classification algorithm executed by the FPGA shown in FIG. 3;

FIG. 6 is a representation of a bright pixel group identification number (BPGIN) array produced by the zone pixel classification algorithm shown in FIGS. 5a and 5b executed by the FPGA shown in FIG. 3;

FIG. 7 is a flowchart of a row centroid algorithm executed by the FPGA shown in FIG. 3;

FIG. 8 is a representation of a bright pixel row centroid (BPRC) array produced from row centroid algorithm shown in FIG. 7;

FIG. 9A and 9B are a flowchart of a bright pixel-grouping algorithm executed by a Digital Signal Processor (DSP) shown in FIG. 3;

FIG. 10 is a representation of a bright pixel group range (BPGR) array produced from bright pixel-grouping algorithm shown in FIGS. 9a and 9b;

FIG. 11 is a flowchart of a bright pixel centroid algorithm executed by the DSP shown in FIG. 3;

FIG. 12 is a representation of a bright pixel group centroid (BPGC) array produced by the bright pixel centroid algorithm shown in FIG. 11;

FIG. 13A and 13B are a flowchart of a group center algorithm executed by the DSP shown in FIG. 3;

FIG. 14 is a representation of output produced by the group center algorithm shown in FIGS. 13A and 13B;

FIG. 15 is a flowchart of a positioning algorithm executed by the host computer shown in FIG. 3; and

FIG. 16 is a flowchart of algorithm executed by the host computer shown in FIG. 3.

### DETAILED DESCRIPTION

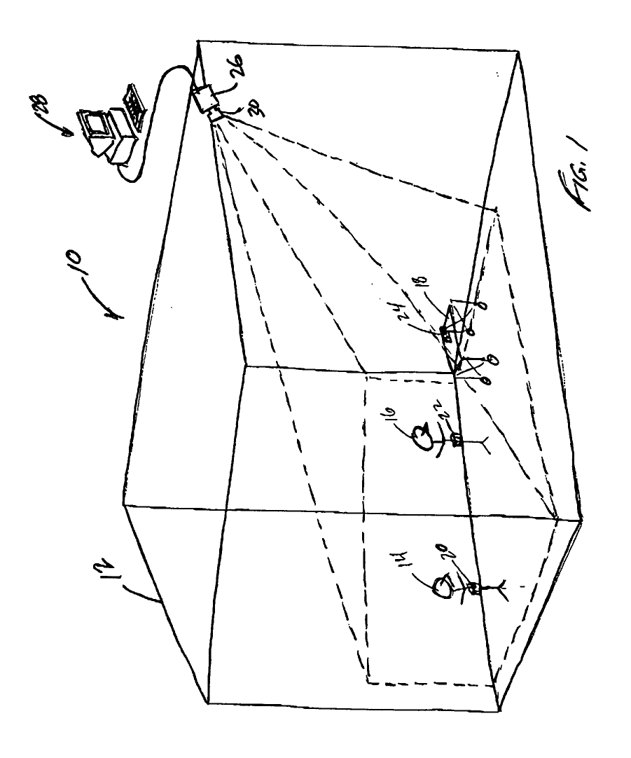

Referring to FIG. 1, a system for finding the position of an object in space is shown generally at 10. In this embodiment, the space is shown as a rectangular trapezoidal area bounded by lines 12, which in reality may represent the intersections of walls, ceiling and floors, for example. Thus, the space may be a room in a building, for example.

Within the space 10, people such as shown at 14 and 16, or objects such as a gurney shown at 18, may be fitted with tag transmitters 20, 22 and 24, respectively, each of which emits radiation in a particular pattern. Alternatively, the tags may reflect incident radiation having an inherent spatial pattern. In general, the pattern may be spatial or temporal, or may be related to a particular wavelength (e.g., color) of radiation emitted. The spatial pattern may be a particular arrangement of bright spots, or reflectors, or colors, for example. In the embodiment shown, each of the tag transmitters 20, 22 and 24 includes a near infrared emitting diode and a circuit for causing the near-infrared emitting diode to produce an unique serial bit pattern. The transmitters are portable and thus are operable to move around the space as the users 14 and 16 move around, and as the gurney 18 is moved around.

The system includes a camera 26 which provides an image of the space at a given time, which is represented by the intensity of light received at various pixel positions in the image. The image has a plurality of rows and columns of pixels. In this embodiment, the camera 26 is a complimentary metal oxide semiconducting (CMOS) black and white digital video camera. Alternatively, the camera 26 may be a charge coupled device (CCD) camera, for example. The CMOS camera is chosen over the more common CCD camera because of its advantage of having an embedded analog-to-digital converter, low cost, and low power consumption. The camera 26 has a variable capture rate, with a maximum value of 50 video frames, i.e. images per second.

The system further includes a processor shown generally at 28, which receives data from the camera 26, in sets, representing the intensity of detected near-infrared energy in each pixel in a row of the image. Thus, the camera provides data representing pixel intensity in pixels on successive rows, or zones, or adjacent zones of the image.

The processor circuit identifies the positions of pixels in the image of the space which satisfy a condition relating to a pixel property associated with an object in the space, it classifies the positions into a group according to classification criteria and produces a group position representation for the group, from positions classified in the group, the group position representation representing the position of the object in the space. The camera 26 also provides a series of different images of the space at different times in the form of video frames, for example comprising the different images.

Referring to FIG. 1, in this embodiment the near-infrared emitters in each of the tag transmitters 20, 22 and 24 has a sharp radiation spectrum, a high intensity and a wide viewing angle. An near-infrared emitter operable to emit near-infrared radiation having a center wavelength between about 850 and 1100 nanometers is desirable and in this embodiment a center wavelength of about 940 nanometers has been found to be effective.

In this embodiment, the camera 26 has a narrow band pass optical filter 30 having a center wavelength of between 850 and 1100 nanometers and more particularly a center wavelength of about 940 nanometers which filters out a significant amount of noise and interference from other sources and reflections within the space. The filter 30 has a half power bandwidth of 10 nanometers permitting virtually the entire spectrum of the near-infrared emitters to pass through the filter, while radiation in other wavelength bands is attenuated. Alternatively, other filters may be used. For example, a low-pass filter may be useful to filter out the effects of sunlight. The filter may be an IR-pass glass filter and/or a gel filer, for example.

The time pattern emitted by each tag 20, 22, and 24 is unique to the tag and in this embodiment includes a 10 bit identification code. The code is designed such that at least three simultaneous bit errors must occur before a tag is unable to be identified or misidentified as another one.

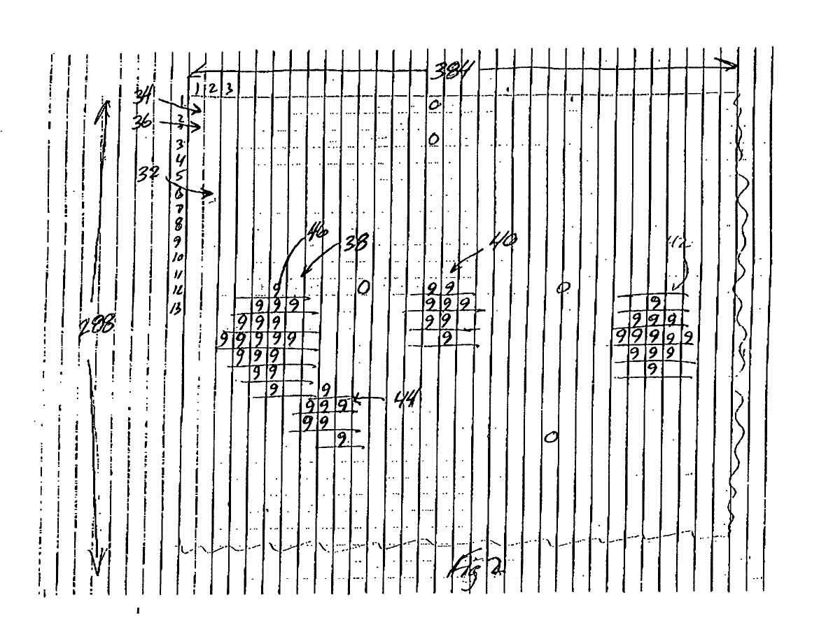

Referring to FIGS. 1 and 2, the camera 26 produces an image of the space 10, as shown generally at 32. The image 32 is comprised of a plurality of zones, two of which are shown at 34 and 36, and in this embodiment the zones are respective rows of pixels across the image. In this embodiment, the image has a resolution of 384 pixels by 288 pixels, meaning that the array has 384 pixels in respective columns along the row and there are 288 rows disposed adjacent each other vertically downwardly in the image. Each pixel position can be identified by a row and column number. In the image 32 shown the camera 26 has detected four bright spots shown generally at 38, 40, 42 and 44, respectively. The bright spots are indicated by pixel intensity values such as shown at 46, which are significantly greater or have greater values than intensity values associated with pixels nearby. In this embodiment all blank pixel locations are assumed to have a zero value although in practice some pixel values may be between minimum and maximum values due to reflections, etc. In this embodiment the intensity of each pixel is represented by a number between 0 and 256 so that each pixel intensity can be represented by an 8 bit byte.

Still referring to FIGS. 1 and 2, the camera 26 sends a set of pixel bytes representing the pixel intensities of pixels in a row of the image 32 to the apparatus 28. For the first row 34, shown in FIG. 2, for example, the camera sends 384 bytes each equal to zero. When the camera sends the twelfth row, for example, it sends five bytes followed by a byte indicating an intensity of 9 followed by eight bytes followed by two bytes, each indicating an intensity of 9, followed by a plurality of zero bytes to the end of the row. As each row is provided by the camera 26, it is received at the apparatus 28 where the positions of pixels in the image of the space which satisfy a condition relating to a pixel property associated with the object are identified and classified. Various criteria for identifying and classifying may be used.

The actions of identifying classifying and producing a group position representation can be performed in a variety of ways. For example, various criteria can be used to identify pixels of interest, such as edge detection, intensity detection, or detection of another property of pixels. For example, the background (average) level of each pixel can be recorded and new pixel values can be compared to background values to determine pixels of interest. Classifying can be achieved by classifying in a single class pixels which are likely to be from the same source. For example if a group of pixels is very near another group, it might be assumed to be from the same source. Producing a group position representation may be achieved by taking a center position of the group, an end position, a trend position, or various other positions inherent in the group. If frames are analyzed as a whole, a two dimensional Gaussian filter and differences might be used to converge to a pixel position which represents a group of pixels.

In this embodiment, a particular way has been chosen which results in fast manipulation of data from the camera, as the data is received, which gives virtual real time positioning of a tag. This has been achieved by identifying bright lines in a row of pixels in the image, finding the centroids of the bright lines, grouping the centroids of adjacent bright lines into a single centroid, and grouping the single centroids which are near to each other to produce a set of distinguishable coordinate pairs representing distinguishable tags. A separate target is associated with each coordinate pair and the target is updated as the coordinate pair changes in successive frames if the object is moving. When a coordinate pair is received within a target, the presence of that coordinate pair is used in decoding occurring over a succession of frames to determine which tag is associated with the target. If a tag has been associated with a target, a coordinate pair received within the target is used in a mapping transform to map the coordinate pair into real space coordinates.

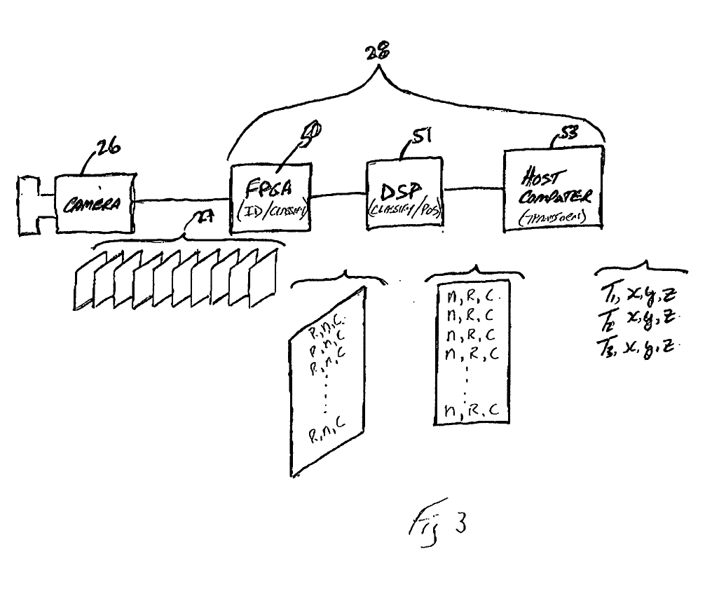

Referring to FIGS. 1, 3 and 4 in this embodiment, the apparatus 28 includes an application specific integrated circuit (ASIC), in particular a field programmable gate array (FPGA) 50 which receives the pixel information provided by the camera 26, a digital signal processor (DSP) 51 which receives pixel information processed by the FPGA and further processes the pixel information and passes it to a processor in the host computer 53. The FPGA of course, may be replaced by a custom ASIC and the DSP may be replaced by a custom ASIC and/or the custom ASIC may incorporate both the functions of the FPGA and the DSP.

The host computer 53 may obtain data from the DSP 51 via a high-speed serial link or if the DSP is located in the host computer, via a parallel bus for example. The FPGA 50 and the DSP 51 are in communication via an internal direct memory access (IDMA) interface which provides a large bandwidth able to handle the through-put provided by the camera 26. In this embodiment, the DSP 51 is an ADSP-2181 DSP chip operating at 33 MHz. The IDMA interface of the DSP 51 allows the FPGA 50 to write directly to the internal memory of the DSP. Thus, the IDMA port architecture does not require any interface logic, and allows the FPGA 50 to access all internal memory locations on the DSP 51. The advantage of using the IDMA interface for data transfer is that memory writes through the IDMA interface is completely asynchronous and the FPGA 50 can access the internal memory of the DSP 51 while the processor is processing pixel information at full speed. Hence the DSP 51 does not waste any CPU cycles to receive data from the FPGA 50. In addition to allowing background access, the IDMA interface further increases the access efficiency by auto-incrementing the memory address. Therefore, once the starting location of a buffer is put into the IDMA control register, no explicit address increment logic or instructions are needed to access subsequent buffer elements.

As mentioned above, because the CMOS digital camera 26 is sampling at 50 frames per second, the DSP 51 has only approximately 20 milliseconds to process pixel information and send the results to the host computer 53. Therefore, to ensure the real-time requirement of processing the video frames in-time is achieved and no data loss will occur, a double-buffering mechanism is used.

In the internal memory of the DSP, two video buffers are dedicated to the operation of double-buffering. These include a receive buffer and an operating buffer. The receive buffer facilitates receipt of data to be processed while the data in the operating buffer is being processed. This mechanism allows the DSP to operate on a frame of video data in the operating buffer while the FPGA is producing another frame of data in the receive buffer. When the FPGA signified the end-of-frame signal, the DSP will swap the function of two buffers and the process repeats.

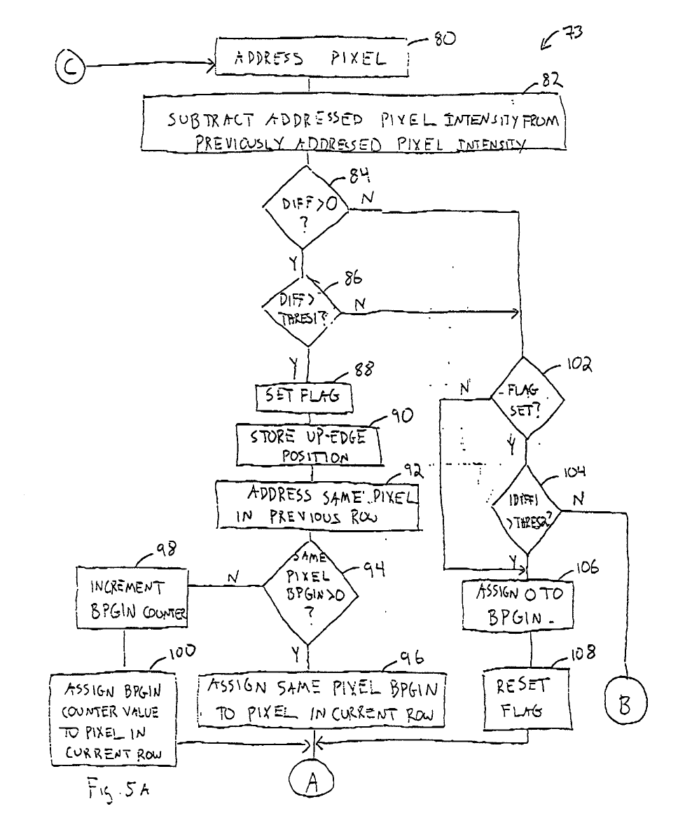

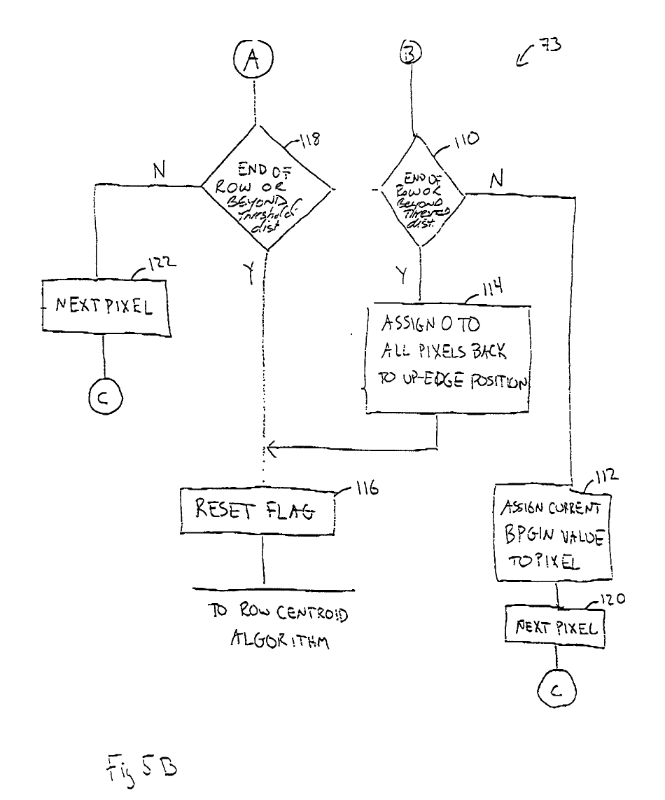

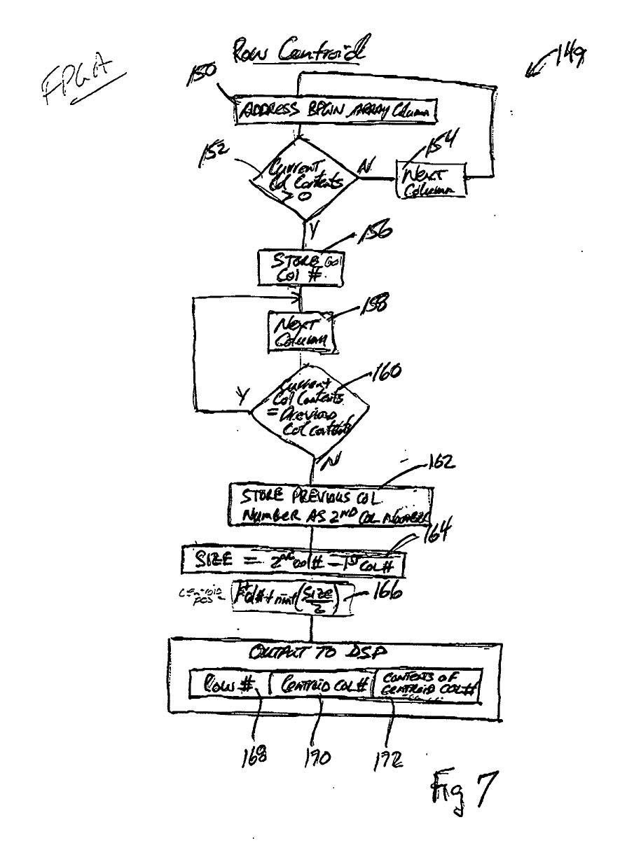

In this embodiment the FPGA 50 and DSP 51 are mounted in the apparatus 28, but alternatively, the FPGA and DSP may be separate from the apparatus. Output data lines from the camera 26 are directly connected to the input pins of the FPGA 50. The FPGA 50 includes a video data register 52 which receives raw video data information representing rows of the image, and over time receives a plurality of frames 27 comprising different images of the space 10. The FPGA 50 further includes a current video data register 54, an edge detection logic circuit 56, a spot number assignment logic circuit 58 and an output buffer 60. Control and synchronization signals are received from the camera 26 at an input 62 to a control and synchronization logic circuit 64 which communicates with a column counter 66 and a row counter 68 to keep track of the row and column of pixels being addressed. The column counter 66 is further in communication with an X position register 70 and the row counter is in communication with a Y position register 72. Effectively, the indicated blocks are coupled together to execute a zone pixel classification algorithm and a row centroid determining algorithm as shown at 73 in FIGS. 5a and 5b, and 149 in FIG. 7, respectively.

### Zone Pixel Classification: FIGS 5a and 5b

Referring to FIGS. 2, 4, 5a and 5b, the function of the zone pixel classification algorithm 73 is to search the pixels in a zone of the image 32 to locate all the bright pixels in the zone from the pixel data sent from the camera 26 to the FPGA 50 for a given zone. The algorithm 73 causes the zone to be examined pixel by pixel to identify the position of pixels in the zone of the image 32 having high intensity values relative to a background and to identify an up-edge or a down-edge representing a boundary of a bright spot in the zone. The algorithm identifies an up-edge or down-edge pixel with the position of the pixel having a difference in intensity relative to an intensity of a nearby pixel, where the difference in intensity is greater than a first threshold or less than a second threshold, respectively.

The algorithm 73 also identifies the pixels located between the up-edge and down-edge pixels of the bright spot. It also associates the locations of the bright spot pixels in the zone with a Bright Pixel Group Identification Number (BPGIN) and records the number, the locations of the bright pixels, and whether an identified pixel is an up-edge or a down-edge pixel in a BPGIN array. Alternatively, the algorithm 73 may identify the positions of pixels having an intensity greater than a threshold value, for example. In other words the zone pixel classification algorithm 73 identifies bright lines in a row of the image. More generally, the algorithm 73 performs a first level of classifying the pixels which satisfy the condition by associating identified pixel positions in adjacent zones and within a threshold distance of each other with the same group.

Before executing the algorithm 73 for the first zone for a given image 32, the FGPA 50 initializes the BPGIN array to indicate that there are no bright spots in any previous zones of the image. This is done, for example, by assigning all elements of the BPGIN array to zero, and sets a BPGIN counter to a zero value.

The zone pixel classification algorithm 73 begins at block 80 by directing the control and synchronization logic 64 to address the first pixel in a row of pixel information just received from the camera 26.

Block 82 then directs the edge detection logic 56 to subtract the currently addressed pixel intensity from a previously addressed, nearby pixel intensity. The nearby pixel may be an adjacent one, for example, or a pixel two away from the pixel under consideration, for example, for more robust operation. If the difference between these two intensities is positive, as indicated at 84, the edge detection logic 56 is directed by block 86 to determine whether or not the difference is greater than a first threshold value. If so, then block 88 directs the edge detection logic 56 to set an up-edge flag and block 90 directs the edge detection logic to store the current pixel position as an up-edge position in the BPGIN array. Block 92 then directs the edge detection logic 56 to address the same pixel location in the previous row in the previous BPGIN array, and then block 94 directs the edge detection logic to determine whether or not the same pixel in the previous row is associated with a non-zero BPGIN. If so, then block 96 directs the edge detection logic 56 to assign the same pixel BPGIN to the pixel addressed in the current row under consideration.

If at block 94, the edge detection logic 56 determines that the BPGIN for the pixel in the row immediately preceding is zero, then block 98 directs the edge detection logic to increment a BPGIN counter and block 100 directs the edge detection logic to assign the new BPGIN count value indicated by the counter updated by block 98, to the pixel position in the row currently under consideration. Thus, the BPGIN array is loaded with a BPGIN count value in the pixel position corresponding to the current pixel position under consideration. In this way, blocks 94 and 96 cause pixel positions immediately below pixel positions already associated with a BPGIN to be assigned the same number and for a new pixel satisfying the identification condition, assigning a new BPGIN count value.

If at block 84 the difference in pixel intensity between nearby pixels is zero or is negative, then block 102 directs the edge detection logic 56 to determine whether or not the up-edge flag has been set. If the up-edge flag has previously been set, then block 104 directs the edge detection logic 56 to determine whether the absolute value of the difference in pixel intensity is greater than a second threshold value and, if so, then block 106 assigns a zero to the current pixel position under consideration and block 108 directs the edge detection logic 56 to reset the up-edge flag. If however, at block 102, the flag had not been sent, then the edge detection logic 56 is directed directly to block 106 to assign zero to the current pixel value under consideration. The effect of blocks 102, 104, 106 and 108 is that if the difference in pixel intensities indicates a decrease in intensity and an increase in intensity had previously been detected on the row, then the decrease in intensity is interpreted as a down-edge.

However, if the difference in pixel intensity does not exceed the second threshold value at block 104, the edge detection logic is directed to block 110 to determine whether or not the currently addressed pixel position is located beyond a threshold distance or an end of row position from the last detected up-edge pixel position. If not, then block 112 directs the edge detection logic 56 to assign the current BPGIN to the current pixel position in the BPGIN array indicating that the current pixel position is also a bright spot. Then block 120 directs the edge detection logic 56 to address the next pixel in the row. If the currently addressed pixel position is beyond a threshold distance or the end of row pixel is currently being addressed, it is determined that the up-edge has been erroneously identified, such as would occur with noisy data. Then block 114 directs the edge detection logic 56 to assign zero to all pixel positions back to the up-edge position determined at block 90. Block 116 then directs the edge detection logic 56 to reset the up-edge flag previously set at block 88. The spot number assignment logic 58 is then activated to execute the row centroid algorithm 149 shown in FIG. 7.

Still referring to FIGS. 5a and 5b, however, after the up-edge flag is reset at block 108, block 118 directs the edge detection logic 56 to determine whether or not the currently addressed pixel is an end of row pixel and, if so, then the up-edge flag set at block 88 is reset at block 116 and then the spot number assignment logic 58 is directed to execute the row centroid algorithm 149 shown in FIG. 7, or if at block 118 the end of row pixel is not being addressed, then block 122 directs the edge detection logic 56 to address the next pixel in the row.

After the zone pixel classification algorithm 73 has processed all the data received for a given zone, the FPGA 50 waits for data representing the next zone to be received before re-starting the zone pixel classification algorithm. This process is continued until all the zones of the image 32 have been received and the FPGA 50 receives an end-of-frame signal from the camera 26. The FPGA 50 then conveys the end-of-frame signal to the DSP 51.

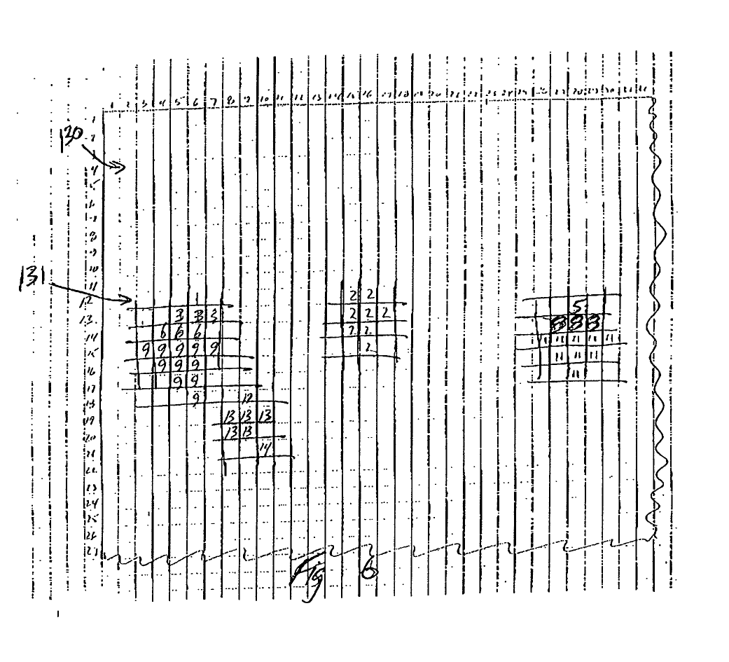

Referring to FIG. 6, a plurality of BPGIN arrays produced by the zone pixel classification algorithm 73 are shown generally at 130 and include a plurality of zeros to a BPGIN array 131 corresponding to the image shown in FIG. 2, row 12 of the image shown in FIG. 2 where the BPGIN counter has been advanced and the pixel position corresponding to pixel position 46 in the image shown in FIG. 2 has been assigned a BPGIN of one. The zeros between column numbers 7-14 determine that the pixel column position 15 is assigned a BPGIN of 2, and the adjacent pixel at column position 16 is assigned the same BPGIN for the next zone represented by row 13, the pixel position at row 13 and column 5 shown in FIG. 2 is assigned a BPGIN of three as are the next two adjacent column pixels. The pixel on row 13 and column 15 is assigned a BPGIN of two since it lies directly underneath a pixel assigned the same BPGIN value. Consequently, the adjacent pixels at columns 16 and 17 are also assigned a BPGIN of two rather than four. Therefore, the zone pixel classification algorithm 73 shown in FIGS. 5a and 5b uses the pixels in the zones of the image 32 shown in FIG. 2 to produce the plurality of BPGIN arrays shown at 130 in FIG. 6. The BPGIN arrays are then processed further by the row centroid algorithm 149 shown in FIG. 7.

### Row Centroid Determination

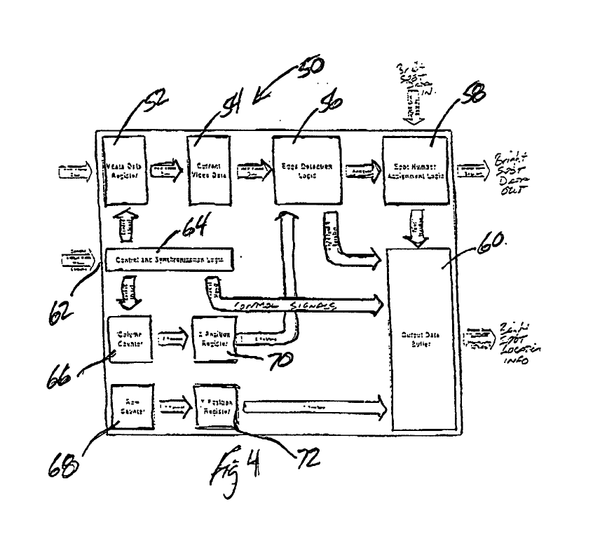

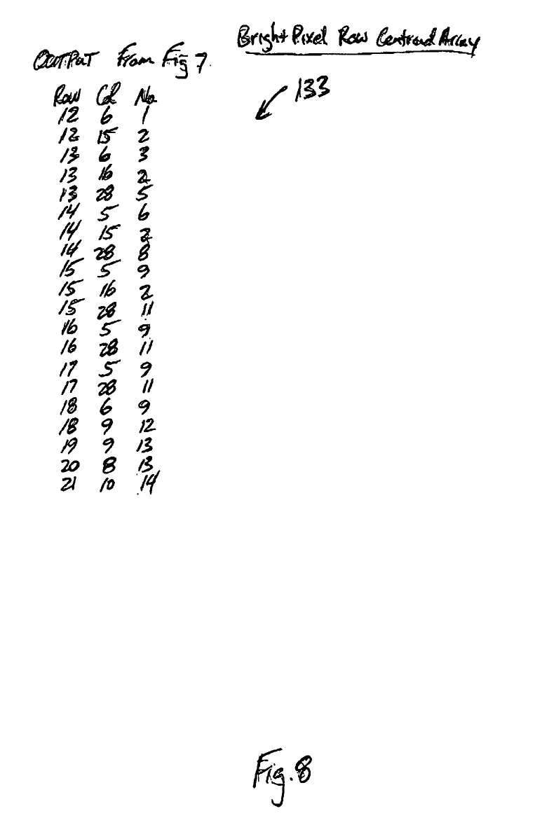

Referring to FIGS. 6 and 7, the row centroid algorithm 149 is executed by the bright spot number assignment logic 58 shown in FIG. 4. The function of the row centroid algorithm 149 is to further condense each BPGIN array 130 into a smaller sized array representing the location of the centroid of the pixels assigned the same BPGIN in each BPGIN array. The centroid information is stored in a bright pixel row centroid (BPRC) array (shown in FIG. 8). Effectively the row centroid algorithm 149 determines the centroids of the bright lines detected by the zone classification algorithm 73.

The row centroid algorithm 149 begins with a first block 150 which directs the spot number assignment logic 58 shown in FIG. 4 to address the first pixel of the row currently under consideration. Block 152 then directs the spot number assignment logic 58 to determine whether the current contents of the pixel currently addressed are greater than zero. If not, then block 154 directs the spot number assignment logic 58 to advance to the next column in the row and to execute block 152 to check the current contents of that column to determine whether the contents are greater than zero.

If the contents of the current addressed column are greater than zero, i.e., a bright spot has been identified by the zone pixel classification algorithm 73 shown in FIG. 5a and 5b, then block 156 directs the spot number assignment logic 58 to store the current column number. Block 158 then directs the spot number assignment logic 58 to advance to the next column and block 160 directs the spot number assignment logic to determine whether the current column contents are equal to the previous column contents. In other words, block 160 directs the spot number assignment logic 58 to determine if both pixels have the same BPGIN. If so, then the spot number assignment logic 58 is directed to block 158 where a loop formed of blocks 158 and 160 causes the processor in the FPGA 50 to advance along each column while the values in the columns are equal, until a value is not equal to the previous value. Then block 162 directs the spot number assignment logic 58 to store the column number of the previous column as a second column value. The effect of this is to identify the beginning and end of a bright line in the corresponding zone of the image.

Block 164 then directs the spot number assignment logic 58 to calculate a size value of the line by taking the difference between the second column number and the first column number. The centroid position is then calculated at block 166 as the nearest integer value (nint) of the size divided by two plus the first column number. Then the current row number 168, the centroid column number 170 determined at block 166, and the contents of the centroid column number 172 are all stored as an entry in the BPRC array and are output to the DSP 51 to represent a group of pixel positions satisfying the condition in a zone. Thus, pixel positions in the same zone satisfying the condition and within a threshold distance of each other are associated with the same group. Thus, in effect the FPGA 50 processes rows of image information to produce a group identifier provided by the contents of the centroid column number, and a position representing the center of the group as indicated by the centroid column number. This is a first step toward determining the position of the object.

Referring to FIG. 8, the BPRC array produced by the row centroid algorithm 149 shown in FIG. 7 is shown generally at 133 in FIG. 8. The BPRC array 133 indicates a bright spot centroid number 1 at row 12 and column 6, a second one centered at column 15, and a third centroid located at row 13, column 6. Another centroid at row 13, column 16 is associated with centroid number 2. As can be seen in the BPRC array 133, different centroids at different locations can be assigned the same BPGIN. Thus, the output of the row centroid algorithm 149 shown in FIG. 7 of the FPGA 50 yields a list of correlated centroid positions in the images.

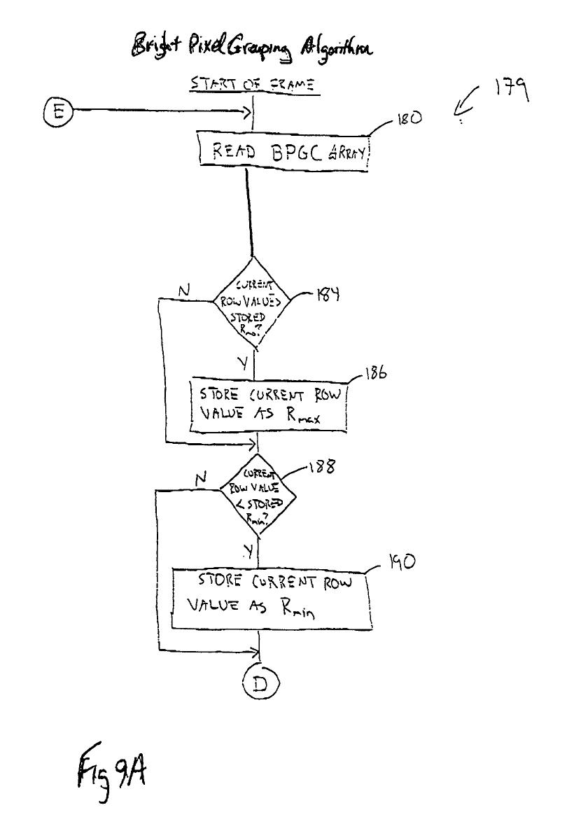

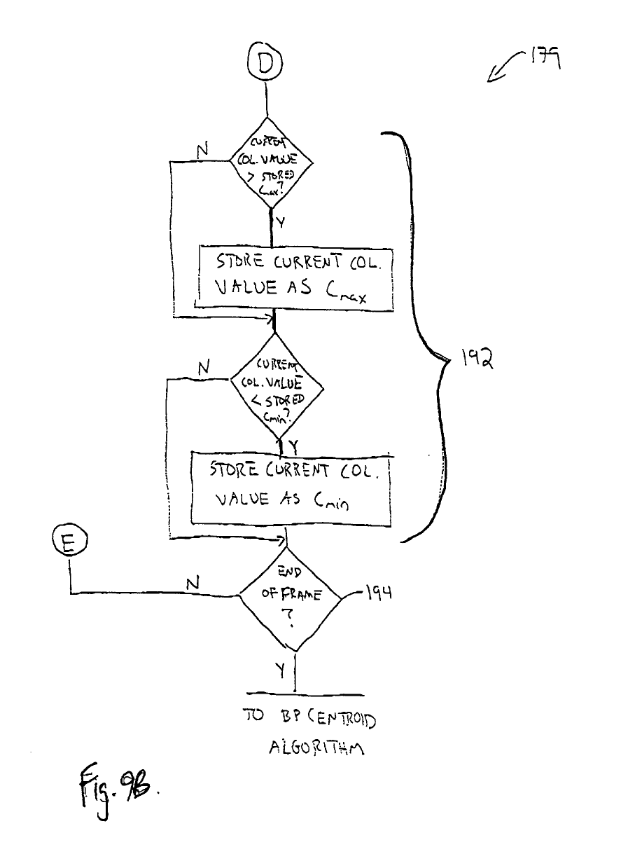

### Bright Pixel Grouping (FIGS. 9A and 9B)

Referring to FIGS. 9A and 9B, operating on receipt of the BPRC array 133 shown in FIG. 8, the DSP 51 executes a bright pixel-grouping algorithm shown at 179 in FIGS. 9A and 9B. The function of the bright pixel-grouping algorithm 179 is to further process the data produced by the FPGA 50 in the BPRC array 133. The bright pixel-grouping algorithm 179 examines the BPRC array 133 and classifies into a single class the groups that have the same BPGIN. In addition, for each group of centroids sharing the same BPGIN, a minimum and maximum centroid coordinate is assigned. After this, a center centroid coordinate is computed by taking the average between the maximum and minimum centroid coordinates for each pixel group. In other words, the bright pixel grouping algorithm 179 produces a single centroid value for each bright line associated with the same BPGIN.

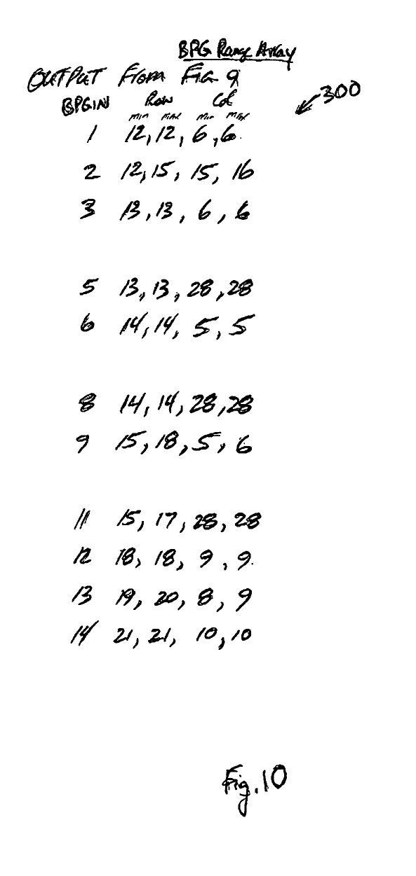

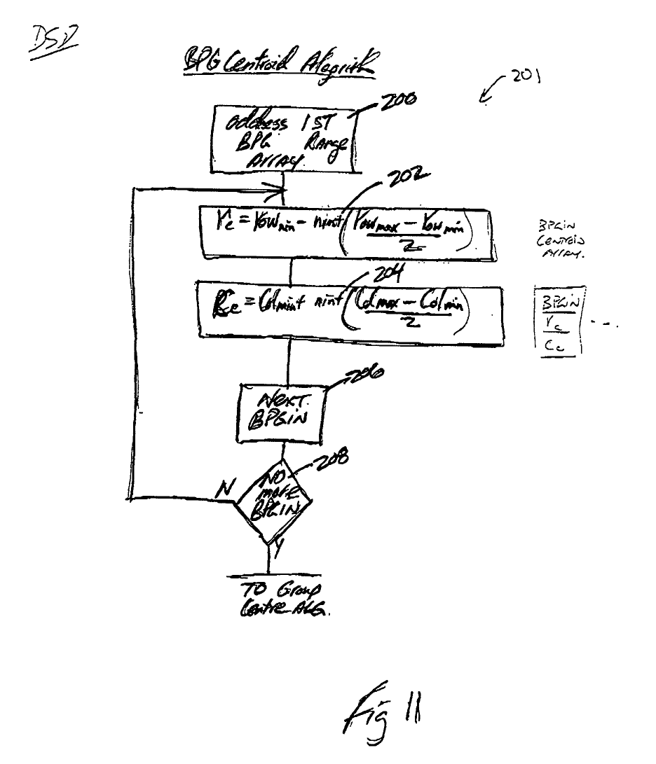

After initializing max and min row and column storage locations, the bright pixel-grouping algorithm 179 begins with a first block 180 which directs the DSP 51 to address and retrieve a BPGIN entry from the BPRC array 133. Block 184 then directs the DSP 51 to determine whether or not the row value of the current BPGIN entry is greater than the current stored maximum row value. If so, block 186 directs the DSP 51 to store the current row value as the stored maximum row value. If the current row value is not greater than the maximum stored row value, the DSP 51 is directed to block 188 to determine whether or not the current row value is less than the current stored minimum row value and, if so, to block 190 directs the DSP 51 to store the current row value as the minimum row value. A similar procedure occurs in block 192 for the column values to effectively produce minimum and maximum row and column values for each BPGIN. This is done on a frame-by-frame basis and serves to effectively draw a rectangle around the maximum and minimum row and column values associated with all BPRC entries associated with a given BPGIN, and output the results in a bright pixel group (BPG) range array as shown in FIG. 10. Block 194 directs the DSP 51 to determine when an end-of-frame is reached and when it has been reached the DSP 51 is directed to a BPGC algorithm shown at 201 in FIG. 11. Otherwise, the DSP 51 is directed back to block 180 where it reads the next BPGIN in the BPRC array 133.

Referring to FIG. 10, the BPGR array produced by the bright pixel-grouping algorithm 179 shown in FIGS. 9a and 9b is shown generally at 300 in FIG. 10. In this embodiment, using the exemplary image of FIG. 2, effectively what is produced is a unique bright spot identification number 1 though 14 shown in FIG. 10 which is associated with the minima and maxima of the rows and columns of the centroids of the image which define the bright spot. Therefore, bright spots assigned the same BPGIN but centered at different locations are grouped together or in other words classified into a single group. Identifications of these bright spots and their locations are passed on to the bright pixel group (BPG) centroid algorithm, shown at 201 in FIG. 11.

Thus, in effect, the bright pixel-grouping algorithm 179 combines group position representations of the plurality of groups associated with a single BPGIN into a single group position representation for the BPGIN, thus further classifying pixel positions and further determining the position of the object.

### Bright Pixel Group Centroid Determination

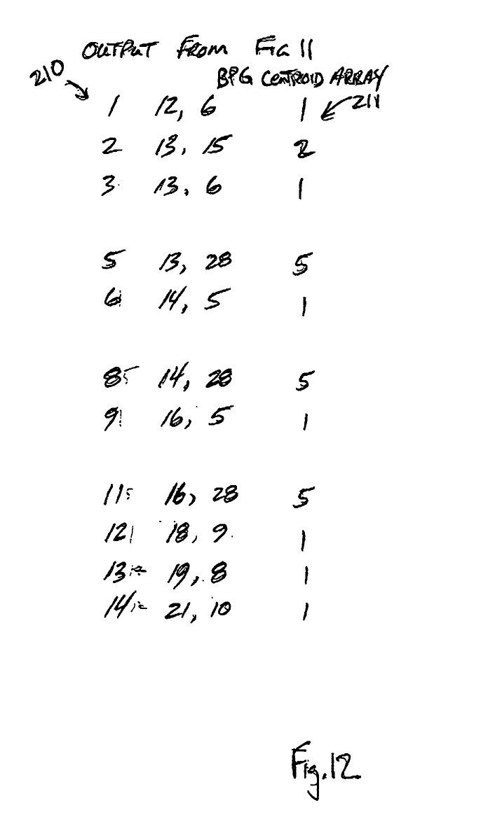

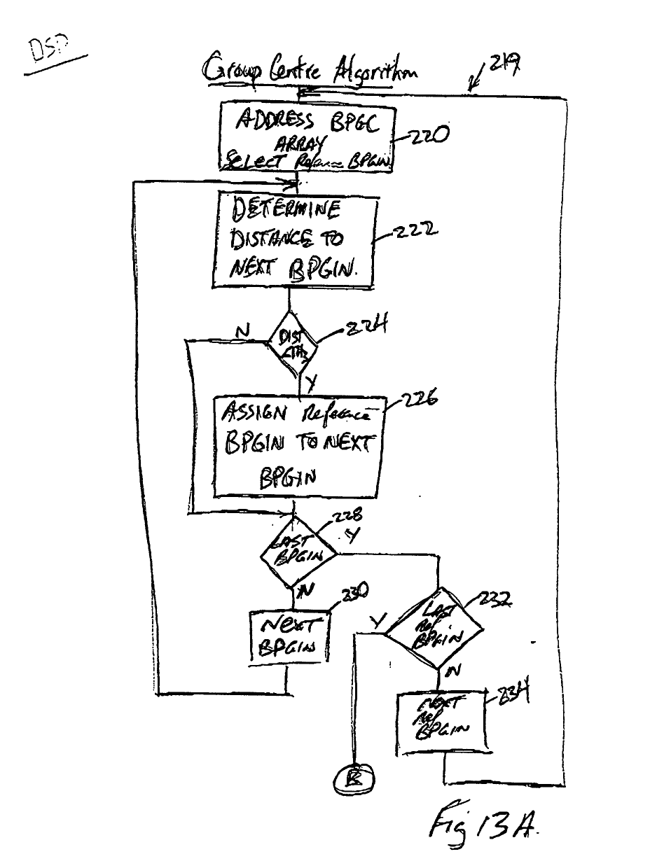

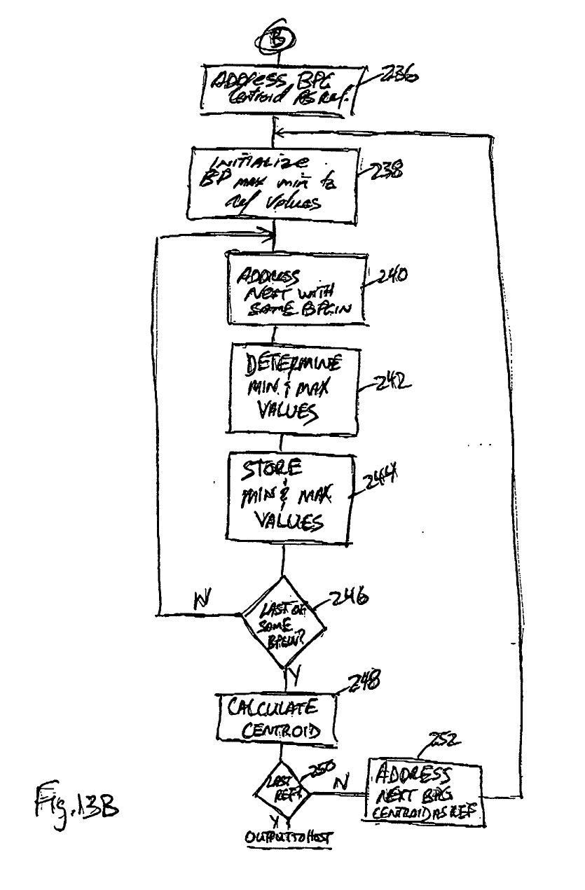

Referring to FIG. 11, the BPGC algorithm 201 begins with a first block 200 which directs the DSP 51 to address the first entry in the BPGR array 300. Then block 202 directs the DSP 51 to calculate a row centroid value which is calculated as the nearest integer value of one-half of the difference between the row maximum value and the row minimum value, plus the row minimum value. Similarly, block 204 directs the DSP 51 to calculate a column centroid value which is calculated as the nearest integer value of one-half of the difference between the column maximum value and the column minimum value, plus the column minimum value. The row centroid value and column centroid values are stored in a Bright Pixel Group Centroid (BPGC) array as shown at 210 in FIG. 12. Block 206 then directs the DSP 51 to address the next BPGIN and block 208 directs the DSP to determine whether or not the last BPGIN has already been considered and, if not, then to calculate row and column centroid value positions for the currently addressed BPGIN. The DSP 51 is then directed to a group center algorithm shown at 219 FIGS. 13A and B.

Referring to FIG. 12, a representation of a bright pixel group (BPG) centroid array is shown generally at 210. The BPGC array 210 represents a list of BPGINs and their associated centroid position locations. This information is passed to the group center algorithm 219 shown in FIGS. 13A and B to further group centroids which are within a minimum distance of each other into a single BPGIN, to provide for further classification of pixel positions and to further determine the position of the object.

Due to the orientation of the near-infrared transmitters 20, 22 and 24 relative to the lens of the camera 26 shown in FIG. 1, the near-infrared signal could appear as non-contiguous bright pixel blocks on the image 32 detected by the camera. As a result, pixels with different BPGINs could belong to the same near-infrared signal. To deal with this, further grouping is done to classify or group together these non-contiguous pixel blocks originating from the same source. The group centre algorithm 219 makes grouping decisions based on the relative proximity among different pixel groups. Effectively, their centroid coordinates are compared with each other and if they are found to be within a predefined minimum distance, they are grouped together into a single group.

### Group Centre Determination

Referring to FIG. 13A and B, the group center algorithm 219 begins with a first block 220 which directs the DSP 51 to address the BPGC array 210 shown in FIG. 12. On addressing a first reference BPGIN value, block 222 directs the DSP 51 to determine the distance from the currently addressed BPGIN to the next BPGIN in the array 210. At block 224, if the distance is greater than a threshold value, then block 226 directs the DSP 51 to assign the reference BPGIN value to the next BPGIN value and then block 228 directs the DSP to determine whether all of the BPGINs in the BPGC array 210 have been compared to the reference BPGIN. If not, then the DSP 51 is directed back to block 222 to determine the distance to the next BPGIN in the BPGC array 210 to the reference BPGIN. The loop provided by blocks 222 through 230, effectively causes the DSP 51 to determine the distance from a given group center to all other group centers to determine whether or not there are any group centers within a threshold distance and, if so, to assign all groups the same BPGIN as the reference BPGIN.

If at block 228 all BPGINs have been compared against the given reference BPGIN, then block 232 directs the DSP 51 to determine whether or not the last reference BPGIN has been addressed and, if not, block 234 directs the DSP then to address the next BPGIN in the BPGC array 210 as the reference BPGIN and rerun the algorithm beginning at block 220. This process is continued until all BPGINs have been addressed for a given image.

The next part of the group centre algorithm 219, shown in FIG. 13B, then determines the maximum and minimum values of centroids having the same assigned BPGIN by first directing the DSP 51 to address a reference bright pixel group centroid at block 236. The DSP 51 at Block 238 is directed to initialize the group centroid maximum and minimum values to the reference values. Block 240 then directs the DSP 51 to address the next centroid having the same BPGIN and blocks 242 and 244 direct the DSP to determine the new centroid row and column maxima and minima, and to store the values, respectively. At block 246, the DSP 51 determines whether all the centroids having the same BPGIN have been addressed, and if not, the DSP is directed back to block 240 to go through all the centroids having the same BPGIN to determine the outer row and column values bounding the group centroids.

When all of the centroids having the same BPGIN have been addressed at block 246, block 248 directs the DSP 51 to calculate the new centroid position of the groups of centroids having the same BPGIN. Block 250 directs the DSP 51 to determine if all of the BPGINs in the BPGC array 210 have been addressed, and if so, the DSP is directed to output the results to the host processor 53. If not, block 252 then directs the DSP 51 to address the next BPGIN in the BPGC array 210 until all of the BPGINs have been addressed.

Upon completion of the group center algorithm 219, all BPGIN values which are spaced apart from each other greater than the third threshold distance, remain in the BPGC array 210 of FIG. 12, and all BPGIN values which are spaced apart within the third threshold distance are grouped into the same BPGIN value The contents of the BPGC array 210 are then provided to the host computer 53 which performs targeting, decoding and positioning functions.

For example, referring back to FIG. 12, a column 211 is shown next to the BPGC array 210 showing the result of the renumbering BPGINs after executing the group centre algorithm 219 in FIG. 13A. Here the third threshold distance has been taken as 5 pixels. Since BPGINs 3, 6, 9, 12, 13, and 14 all have their corresponding centroid positions within a threshold of 5 pixels in both row and column distances, they all have been re-assigned a BPGIN value of 1.

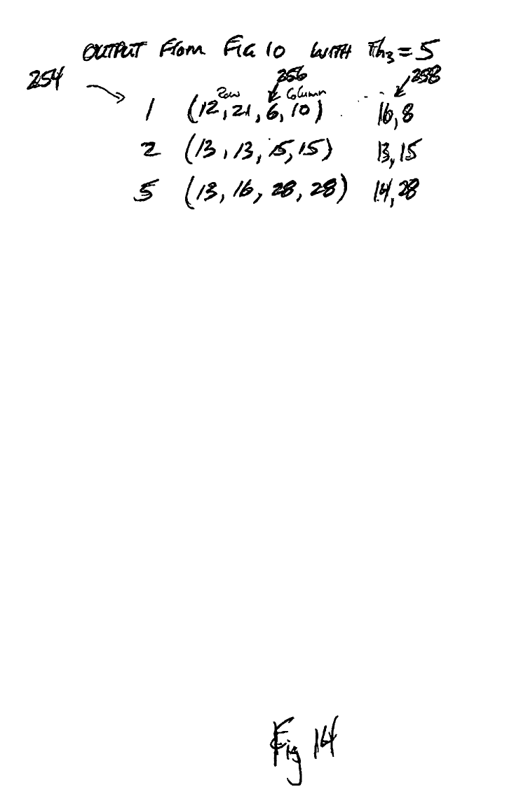

Referring to FIG. 14, the output of the group center algorithm 219 shown in FIG. 13 is shown generally at 254. The algorithm has been applied to the BPGC array 210 shown in FIG. 12 with the assumption that the minimum, or threshold distance is five pixels. In this embodiment, the eleven BPG centroids shown in the BPGC array 210 have been reduced to three centroids shown at 254 in FIG. 14 having row and column maxima and minima as indicated at 256, and row and column centroid positions shown at 258. Thus, the FPGA 50 and the DSP 51 have taken the pixel information data recorded in the image by the camera shown at 32 in FIG. 2 and has reduced it to the output from the bright pixel-grouping algorithm shown at 254 in FIG. 14. In this way, a number of spurious points not associated with different near-infrared emitters have been eliminated. Thus, in effect, pixel positions satisfying the condition determined by the FPGA 50 and within a threshold distance of each other are associated with the same group, and pixel positions within the same zone and adjacent zones within a threshold distance of each other are also associated with the same group. This information is then passed to the host processor 53 in order to identify the identity of the near-infrared emitters and to track their position as a function of time in the space 10 shown in FIG. 1. The information may be passed to the host processor in a variety of ways including, for example, an RS-232 connection, a Universal Serial Bus (USB) connection, an Internet Protocol Connection, a firewire connection, or a wireless connection.

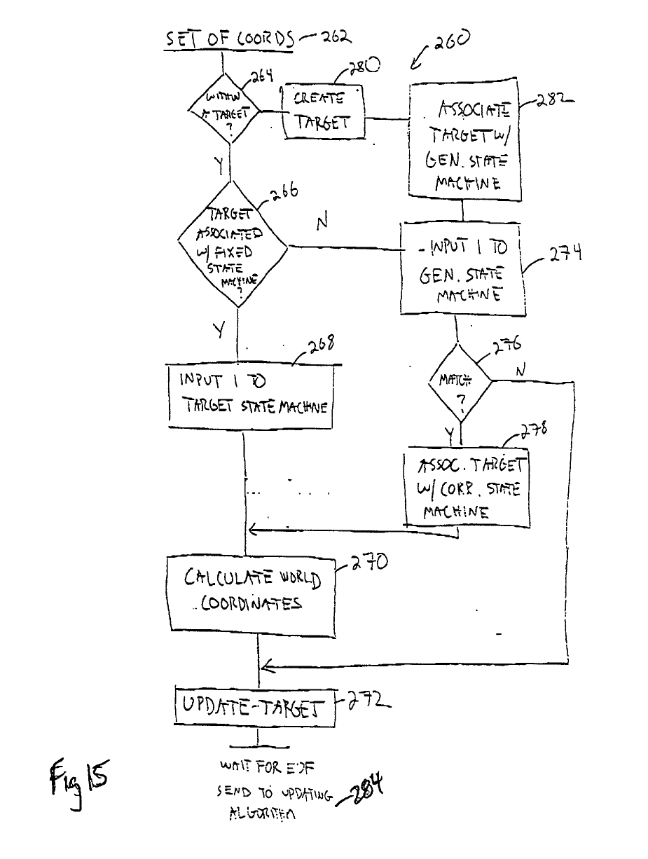

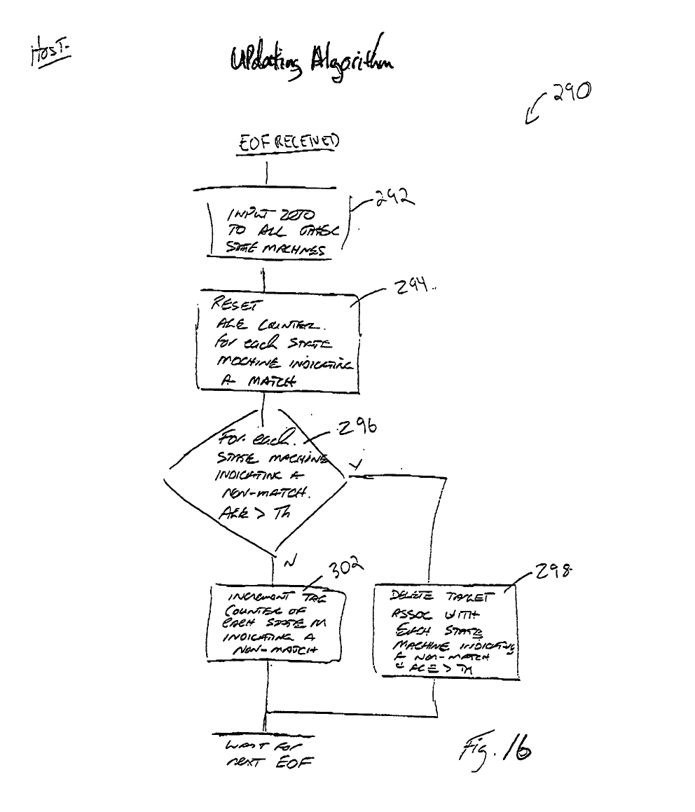

Referring to FIG. 15, a positioning algorithm is shown generally at 260, which is executed by the host processor 53 upon receipt of the output 258 of the group center algorithm 219 executed by the DSP 51. The host processor 53 receives from the DSP 51 the row and column co-ordinates of each group of bright spots 258 shown in FIG. 14 produced by the group center algorithm 219. This is indicated at block 262. Block 264 directs the host processor 53 to determine whether or not the received co-ordinates are within a target. If so, then block 266 directs the host processor 53 to determine whether the target has been associated with a fixed state machine indicating whether the target has been uniquely identified with a particular tag. If so, block 268 directs the host processor 53 to input a one to the associated target's state machine, and block 270 directs the host processor to calculate the space coordinates of the tag from the pixel coordinates (258) given at block 262. Block 272 directs the host computer 53 to redefine the target to be centered on the new co-ordinates and wait until an end-of-frame signal sent by the DSP 51 is received. If the end-of-frame signal has not been received before a next set of co-ordinates is received, the process is repeated at block 262. If the end-of-frame signal has been received, then block 284 sends the end-of-frame signal to the updating algorithm 290 shown in FIG. 16.

The state machines implement respective decoding functions associated with respective tags and decode a series of ones and zeros associated with respective tags to try to identify a match. A one or zero is received for each frame analyzed by the FPGA 50 and the DSP 51, thus, in this embodiment, after receiving a sequence of 10 zeros and ones a matching sequence produced by a tag is considered to have been detected and its coordinates in the space are calculated from the last received position. To do this, the host processor 53 computes the space co-ordinates for each state machine indicating a match. These space co-ordinates are computed based on previous knowledge of a mapping between specific known positions in the image space to image positions on the image produced by the camera. This is discussed further below.

If it has been determined at block 266 that the set of coordinates of the centroid is within a target which has not been associated with a particular state machine, then block 274 directs the host processor 53 to input a 1 to a general state machine to determine if the tag can be identified. Block 276 then directs the host processor to determine if there is a match to the bit pattern, produced by the tag and if so, block 278 directs the host processor to associate the target with a corresponding fixed state machine indicating that the target has been identified with a tag. The space coordinates of the tag are then calculated at block 270 and the target information is updated at block 272.

If at block 264 it has been determined that the set of coordinates is not within a pre-existing target area, block 280 directs the host processor 53 to create a target around the received co-ordinates. The target may be defined by rows and columns identifying boundaries of a square centroid on the received coordinates, for example. Block 282 then directs the host processor 53 to associate the target with another general state machine in order to facilitate the detection of a bit pattern to identify the tag. Block 274 then directs the host processor 53 to enter a 1 into the general state machine and block 272 is then entered to update the target coordinates.

Thus, in effect, the positioning algorithm 260 correlates successively received group position representations representing positions within a distance of each other, and determines whether the successive group position representations are within the same target area. The algorithm 260 redefines the target area to compensate for movement of the object in the space 10.

Since a new bit from any given tag is expected in each frame and since new bits may include zeros, the targets must stay in existence for a period of time and targets which do not receive co-ordinates within a frame must have a zero applied to their corresponding state machines. This is done by an updating algorithm as shown at 290 in FIG. 16.

Referring to FIG. 16, the updating algorithm 290 is initiated in response to an end of frame signal and begins with a first block 292 which directs the host processor 53 to input a zero value to all state machines which did not receive a one in the frame which has just ended. In this way, state machines associated with targets which receive a group position representation receive a binary one as their input and all other state machines receive a binary zero as their input.

Block 294 then directs the host processor 53 to reset an age counter for each state machine indicating a match and block 296 directs the host processor to determine which state machines indicating a non-match have an age counter value greater than a threshold value. Block 298 then directs the host processor 53 to delete the targets associated with each state machine indicating a non-match and having an age greater than the threshold value. Thus, in effect, targets are deleted when the received bit pattern does not match a pattern associated with the object. Block 302 directs the host processor 53 to increment the tag counter of each state machine indicating a non-match. The host processor 53 is then directed to wait for the next end-of-frame signal whereupon the algorithm 290 is rerun.

The host processor 53 is responsible for determining a relationship between a tag's pixel coordinates in the image 32 and its associated space coordinates in the space 10. The host processor 53 thus performs a mapping which maps pixel coordinates into space coordinates. The process of computing this mapping is known in the literature as camera calibration (Olivier Faugeras, “Three Dimensional Computer Vision: A Geometric Viewpoint, MIT Press, 1993: page 51). Defining r as a vector representing the coordinates of the pixels in the image 32 and R as a vector representing the space coordinates of the tag in the space 10, a projection matrix M relates the two vectors via the matrix equation r×M=R. The matrix M represents a spatial transformation and a unitary rotation, and a scale transformation of the pixel coordinates into the space coordinates. Therefore, if the components of the matrix M and the pixel coordinates are known, the matrix equation can be solved using general matrix solving equations such as those given in Numerical Recipes, for example, to invert the equations to determine the tag's space coordinates.

The dimensions of the vectors r, R and the dimension of the transformation matrix M are known. The pixel coordinates are inherently two dimensional since they represent pixels in a projected image 32 of the space 10, while the space coordinates are inherently three dimensional since they represent the position of the tag in the space 10. However, it is more convenient to generalize the dimensions of the vectors r, R to account for the aggregate transformations which are applied by the matrix M. The vector r may be represented as a three dimensional vector comprising two components which relate to the pixel coordinates and one component which is an overall scale factor relating to the scale transformation of the space coordinates into pixel coordinates: r=(u, v, s). Similarly, the vector R may be represented as a four dimensional vector having three components representing the space coordinates X, Y, Z with an additional component also representing the scale transformation: R=(X, Y, Z, S). Since only the pixel coordinates are scale-transformed, it can be assumed that S=1 with no loss of generality. Therefore the transformation matrix M is a three by four matrix.

The components of the transformation matrix M are identified by calibrating the camera 26. This is achieved by specifying a set of space coordinates and associating them with a set of corresponding pixel coordinates. Since the transformation matrix M in general has twelve unknowns, twelve equations are needed in order to uniquely solve for the elements of the transformation matrix. This requires that at least six pairs of pixel coordinates and space coordinates must be used to calibrate the camera 26. This task can be simplified by assuming that a tag lies in a fixed altitude plane (Z=constant) in the space 10, thus assuming that the tracking region is planar. The transformation matrix is thus simplified, as one column can be set to zero, resulting in a three by three matrix having only eight unknowns. Therefore, only four pairs of pixel coordinates and space coordinates are needed to calibrate the camera 26.

However, due to measurement errors in the space coordinates and round off errors in the matrix calculations, a unique solution might not be obtained by just four pairs of points. In the worst case, the matrix becomes singular and no solutions exist. To get a reliable solution and higher accuracy in image-space mapping, a larger set of coordinates should be used. The resulting overdetermined system of equations can be solved by a least-squares fit method (i.e., pseudo-inverse or singular value decomposition, as specified in Numerical Recipes, for example). It has been found that thirteen calibration coordinates are enough to represent the entire region and give an accurate mapping. Once the elements of the transformation matrix M are computed, the matrix inversion can then be inverted for a given set of pixel coordinates to determine space coordinates. Therefore, in effect, the host processor 53 transforms the group position representation into a space position representation, wherein the space position representation represents position coordinates of the object in the space 10.

The limitation of assuming a planar tracking area may be eliminated if an additional image is used from a different camera placed at another location in the space 10. The two cameras record separate images in separate pixel coordinates for the same tag emitter emitting radiation in the space 10. A plurality of cameras may be similarly located in each of the four corners or in opposite corners of the space 10, to better track and detect tags which may be behind objects which block the view of a particular camera. In this case, each camera would be associated with its own FPGA and DSP. Therefore, there are four equations for the three unknowns R to determine from the matrix equation, and the object can be uniquely positioned in the space 10. Additional cameras can be used to reduce errors associated with matrix inversion and measurement errors, for example, to provide for greater precision in determining the position of the object. In addition, further post processing may be performed on the host computer to take into account the condition where tags may move behind objects out of the view of some cameras and come into view of others.

The space position representation may be displayed on a computer display or may be used to develop statistical data relating to the time which objects are in proximity to certain points in the space for example.

In addition to producing a space position representation it is possible that each tag may have a plurality of near infrared emitters to produce a grouping of bright spots, such as perhaps three bright spots arranged at the vertices of a triangle. Each tag may have a different triangle arrangement, such as an isosceles triangle, or a right triangle, for example. Using this scheme the host computer may be programmed with further pattern recognition algorithms which add pattern recognition to the bit stream decoding described above. Such pattern recognition algorithms may also incorporate orientation determining routines which enable the host cost computer to not only recognize the particular pattern of bright spots associated with a tag, but also the orientation of the recognized pattern.

It will be appreciated that in the embodiment described the camera produces data sets representing pixel intensities in rows of the image, as the image is acquired. With most CMOS Cameras, the frame production rate is typically 30 frames per second. Thus in effect, the sampling rate of the target areas is 30 samples per second. Consequently, the bit rate of the tags must be no more than 30 bits per second. However, since the bit stream produced by each tag is asynchronous relative to the system (and the other tags), it is possible that bits may be missed or may go undetected by the system. To reduce this effect, the timing between bits is randomized at the tags by adjusting the timing between successive bits of a data packet transmitted by the tag or by adjusting the timing between successive packets. This reduces the occurrences of bits received from the tags being perfectly lined up with the sampling provided by each frame capture. Thus it is likely that only one bit in any transmission would not be properly received. Therefore, a one or more bit error correcting code may be used to encode the data packets transmitted by the tags, to increase the reliability of the system. In addition, the shutter speed of the camera may be increased to improve the sampling function, depending on the intensity of the radiation emitted from the tags.

While the embodiment described above employs near-infrared energy to transmit encoded data packets, other forms of energy may be used. For example sound energy may be used in some applications, or radio frequency energy in spectra other than the 850-1100 near infra red spectrum may be used. Near infra red energy is a practical form of energy to use for the purpose indicated since it can't be seen by humans and doesn't produce significant reflections off of most surfaces.

A system of the type described above may be of value to a hospital to track and secure valuable health care assets, to quickly locate doctors and nurses in emergency situations, and to limit the access of personnel to authorized zones. Another interesting application would be tracking visitors and providing them with real time information in a large, and possibly confusing, exhibition. Another interesting application may be in tracking performers on stage. Another application may be to track the movement of people into different areas of a building and adjusting a call forwarding scheme so that they may automatically receive telephone calls in such different areas.

In another use of the system, the system may be integrated with a GPS system to provide continuous tracking, which may be useful with couriers, for example. The GPS system may be used to track the courier while the courier is outside and the above described positioning system may be used to track the same courier when the courier is inside a building.

Researchers (especially in psychology) can also use the system described herein to observe behavior patterns of animals in experiments. For example, in an eating pattern experiment each subject would wear a tag that has a unique ID. Instead of having a researcher manually observing and recording the eating behaviors of each subject, he/she can use the LPS to identify the subjects and record their patterns automatically. This saves both time and cost, especially for experiments with many subjects.

The system can also be extended to be a network appliance with a direct connection to the Internet, possibly through embedding Linux into the system, for monitoring purposes. For example, the user can locate and monitor children or pets inside a house from a remote location through a regular WWW browser.

While specific embodiments of the invention have been described and illustrated, such embodiments should be considered illustrative of the invention only and not as limiting the invention as construed in accordance with the accompanying claims.

What is claimed is:

1. A method of finding the position of an object in a space, the method comprising:
identifying the positions of pixels in an image of the space, which satisfy a condition relating to a pixel property associated with the object;
classifying said positions into a group according to classification criteria; and
producing a group position representation for said group, from positions classified in said group, said group position representation representing the position of the object in the space.

2. The method of claim 1 further comprising producing said image.

3. The method of claim 2 further comprising dividing said image into zones.

4. The method of claim 3 wherein identifying comprises identifying said positions of pixels in a zone of said image, which satisfy said condition.

5. The method of claim 3 further comprising dividing said image into adjacent zones.

6. The method of claim 5 wherein classifying comprises associating said pixel positions satisfying said condition and in a zone, with the same group as pixel positions satisfying said condition and in an adjacent zone and within a threshold distance of each other.

7. The method of claim 1 wherein identifying comprises identifying the position of an up-edge pixel having a difference in intensity relative to an intensity of a nearby pixel, where said difference in intensity is greater than a threshold value.

8. The method of claim 7 wherein identifying comprises identifying the position of a down-edge pixel having a difference in intensity relative to an intensity of a nearby pixel, where said difference in intensity is less than a threshold value.

9. The method of claim 8 wherein identifying comprises identifying the positions of pixels between said up-edge and said down-edge pixels.

10. The method of claim 1 wherein identifying comprises identifying the positions of pixels having an intensity greater than a threshold value.

11. The method of claim 1 wherein classifying comprises associating said pixel positions satisfying said condition and within a threshold distance of each other with the same group.

12. The method of claim 1 wherein classifying comprises classifying said positions into a plurality of groups and combining group position representations of said plurality of groups into a single group position representation.

13. The method of claim 12 wherein classifying comprises associating said pixel positions in the same zone satisfying said condition and within a threshold distance of each other with the same group.

14. The method of claim 13 wherein classifying comprises associating said pixel positions in adjacent zones satisfying said condition and within a threshold distance of each other with the same group.

15. The method of claim 14 wherein classifying comprises associating said pixel positions satisfying said condition and within a threshold distance of each other with the same group.

16. The method of claim 12 further comprising correlating successive group position representations representing positions within a distance of each other.

17. The method of claim 16 further comprising determining whether said successive group position representations are within a target area.

18. The method of claim 17 further comprising redefining said target area to compensate for movement of the object in the space.

19. The method of claim 18 further comprising identifying a pattern in said group position representation.

20. The method of claim 19 further comprising identifying a spatial pattern in a set of group position representations.

21. The method of claim 19 further comprising identifying a time pattern in said group position representation.

22. The method of claim 19 further comprising associating said group position representation with an object when said pattern matches a pattern associated with the object.

23. The method of claim 22 further comprising deleting said target area when said pattern does not match a pattern associated with the object.

24. The method of claim 12 further comprising transforming said group position representation into a space position representation, wherein said space position representation represents position coordinates of the object in the space.

25. The method of claim 1 further comprising executing the steps of claim 1 for each of at least one different image of the space to produce group position representations for each group in each image.

26. The method of claim 25 further comprising transforming said group position representations into a space position representation, wherein said space position representation represents position coordinates of the object in the space.

27. The method of claim 26 further comprising producing a representation of orientation from a plurality of space position representations.

28. An apparatus for finding the position of an object in a space, the apparatus comprising:
means for identifying the positions of pixels in an image of the space, which satisfy a condition relating to a pixel property associated with the object;
means for classifying said positions into a group according to classification criteria; and
means for producing a group position representation for said group, from positions classified in said group, said group position representation representing the position of the object in the space.

29. A computer readable medium for providing instructions for directing a processor circuit to:
identify the positions of pixels in an image of the space, which satisfy a condition relating to a pixel property associated with the object;
classify said positions into a group according to classification criteria; and
produce a group position representation for said group, from positions classified in said group, said group position representation representing the position of the object in the space.

30. An apparatus for finding the position of an object in a space, the apparatus comprising:
a circuit operable to identify the positions of pixels in an image of the space, which satisfy a condition relating to a pixel property associated with the object;
a circuit operable to classify said positions into a group according to classification criteria; and
a circuit operable to produce a group position representation for said group, from positions classified in said group, said group position representation representing the position of the object in the space.

31. The apparatus of claim 30 further comprising an image-producing apparatus operable to produce said image.

32. The apparatus of claim 31 wherein said image-producing apparatus comprises a charge coupled device.

33. The apparatus of claim 31 wherein said image-producing apparatus comprises a complementary metal-oxide semiconductor device having an analog-to-digital converter.

34. The apparatus of claim 30 further comprising a plurality of image-producing apparati.

35. The apparatus of claim 31 wherein said image-producing apparatus further comprises a filter.

36. The apparatus of claim 30 wherein said circuit operable to identify and said circuit operable to classify comprise a common application specific integrated circuit.

37. The apparatus of claim 30 wherein said circuit operable to identify and said circuit operable to produce comprise a common digital signal processor.

38. The apparatus of claim 37 wherein said digital signal processor comprises an operating buffer and a receive buffer, the receive buffer facilitating receipt of data to be processed while the data in the operating buffer is being processed.

39. The apparatus of claim 38 wherein said circuit operable to produce further comprises a computer.

40. The apparatus of claim 30 wherein said circuit operable to identify is operable to identify positions of pixels in a zone of said image, which satisfy said condition.

41. The apparatus of claim 40 wherein said circuit operable to identify is operable to associate said pixel positions satisfying said condition and in a zone, with the same group as pixel positions satisfying said condition and in an adjacent zone and within a threshold distance of each other.

42. The apparatus of claim 30 wherein said circuit operable to identify is operable to identify the position of an up-edge pixel having a difference in intensity relative to an intensity of a nearby pixel, where said difference in intensity is greater than a threshold value.

43. The apparatus of claim 42 wherein said circuit operable to identify is operable to identify the position of a down-edge pixel having a difference in intensity relative to an intensity of a nearby pixel, where said difference in intensity is less than a threshold value.

44. The apparatus of claim 43 wherein said circuit operable to identify is operable to identify the positions of pixels between said up-edge and said down-edge pixels.

45. The apparatus of claim 30 wherein said circuit operable to identify is operable to identify the positions of pixels having an intensity greater than a threshold value.

46. The apparatus of claim 30 wherein said circuit operable to classify is operable to associate said pixel positions satisfying said condition and within a threshold distance of each other with the same group.

47. The apparatus of claim 30 wherein said circuit operable to classify is operable to classify said positions into a plurality of groups and to combine group position representations of said plurality of groups into a single group position representation.

48. The apparatus of claim 30 wherein said circuit operable to produce is operable to correlate successive group position representations representing positions within a distance of each other.

49. The apparatus of claim 48 wherein said circuit operable to produce is operable to determine whether said successive group position representations are within a target area.

50. The apparatus of claim 49 wherein said circuit operable to produce is operable to redefine said target area to compensate for movement of the object in the space.

51. The apparatus of claim 50 wherein said circuit operable to produce is operable to identify a pattern in said group position representation.

52. The apparatus of claim 51 wherein said circuit operable to produce is operable to identify a spatial pattern in a set of group position representations.

53. The apparatus of claim 51 wherein said circuit operable to produce is operable to identify a time pattern in said group position representation.

54. The apparatus of claim 51 wherein said circuit operable to produce is operable to associate said group position representation with an object when said pattern matches a pattern associated with the object.

55. The apparatus of claim 54 wherein said circuit operable to produce is operable to delete said target area when said pattern does not match a pattern associated with the object.

56. The apparatus of claim 30 wherein said circuit operable to produce is operable to transform said group position representation into a space position representation, wherein said space position representation represents position coordinates of the object in the space.

57. A system comprising the apparatus of claim 30 and further comprising:
a housing securable to a movable object movable within a space;
an energy radiator on said housing operable to continuously radiate energy; and
a circuit operable to cause said energy radiator to continuously radiate energy in an encoded radiation pattern; and
an image-producing device operable to produce an image representing at least a portion of the object, said image being represented by a plurality of pixels.

58. A system for finding the position of an object in a space, the system comprising a plurality of apparatuses as claimed in claim 30 and further comprising:
a plurality of image producing apparatus operable to produce respective images of the object in the space; and
a processor circuit operable to produce a space position representation for the object in the space from group position representations produced by respective apparatuses as claimed in claim 30.

59. The system of claim 58 wherein said processor circuit is operable to produce a representation of orientation from a plurality of space position representations.
